(19) United States
(12) Patent Application Publication
(10) Pub. No.: US 2026/0308789 A1
(43) Pub. Date: Oct. 8, 2026

(54) DETECTION OF DAMAGE TO COMPONENTS WITHIN AN ELECTROLYZER STACK DURING OPERATION

(71) Applicant: Fourier Earth, Inc., Mountain View, CA (US)

(72) Inventors: Carl Taussig, Mountain View, CA (US); Simon Gorbet, Mountain View, CA (US); Prasanna Mani, Fremont, CA (US); Lauren Vallez, Mountain View, CA (US); Ali-Amir Aldan, Mountain View, CA (US)

(21) Appl. No.: 19/419,187

(22) Filed: Dec. 15, 2025

Related U.S. Application Data
(60) Provisional application No. 63/784,299, filed on Apr. 7, 2025.

(51) Int. Cl. C25B 15/023; C25B 1/04; G01N 29/44; G01N 29/46; G01N 29/48; G08B 21/18

(52) U.S. Cl. CPC C25B 15/023; C25B 1/04; G01N 29/4427; G01N 29/4436; G01N 29/46; G01N 29/48; G08B 21/182; G08B 21/185; G01N 2291/2634

(57) ABSTRACT

An electrolyzer producing hydrogen. According to an aspect, the electrolyzer contains a stack producing a first fluid containing oxygen and a second fluid containing hydrogen upon application of voltage across the stack. A first pipe carries the first fluid away from the stack. A sensor is operable to send vibration signals representing a measure of vibrations of the first pipe when carrying the first fluid away from the stack, and a detection system operates to detect damage to one or more components within the stack based on the vibration signals.

### PRIORITY CLAIM

The instant patent application is related to and claims the benefit of co-pending US provisional patent application entitled “Operational Monitoring of an Electrolyzer”, Ser. No. 63/784,299, Filed: 7 Apr. 2025, Attorney docket no.: FOUR-004-USPR, which is incorporated in its entirety herewith to the extent not inconsistent with the description herein.

### BACKGROUND

### Technical Field

The present invention relates to electrolyzers producing hydrogen, and more specifically to detection of damage to components within an electrolyzer stack during operation.

### Related Art

Electrolyzers are used for the production of hydrogen (H₂) through electrolysis of water, as is well known in the relevant arts. An electrolyzer typically contains multiple electrolyzer cells, with each cell producing hydrogen at the cathode and oxygen at anode by passing an electric current and water, as is also well known in the relevant arts. Several cells are assembled in series as a stack, with the electrolyzer often containing multiple stacks.

Sometimes, there may be damages to components within an electrolyzer stack. Damage refers to any physical defect/degradation over time that impairs the normal expected function of the components (manifested as unacceptable outputs). For example, there may be rupture in (damage) cell membranes, failure (e.g., tearing, permanent deformation, etc.) of sealing components, etc. which may lead to hydrogen crossover to the anode above accepted levels.

The crossover of hydrogen to the anode results in mixing of hydrogen and oxygen that can lead to combustion (and explosion), and it is accordingly desirable that such damages be detected as soon as possible during operation (i.e., when hydrogen is being produced) so that any necessary corrective action can be taken timely thereby avoiding undesirable consequences.

Aspects of the present disclosure are accordingly directed to detection of damage to components within an electrolyzer stack during operation.

### BRIEF DESCRIPTION OF THE VIEWS OF DRAWINGS

Example embodiments of the present disclosure will be described with reference to the accompanying drawings briefly described below.

FIG. 1 is a block diagram illustrating the details of a hydrogen production system in which several aspects of the present disclosure can be implemented.

FIG. 2 is a block diagram illustrating the details of electrolyzer stack in an embodiment of the present disclosure.

FIG. 3 is a block diagram illustrating the details of a Proton Exchange Membrane (PEM) electrolyzer cell in an embodiment.

FIG. 4 is a block diagram illustrating the example use of an accelerometer sensor in a hydrogen production system, in an embodiment of the present disclosure.

FIG. 5 is a flow chart illustrating the manner in which damage(s) to components within an electrolyzer stack are detected during operation, according to several aspects of the present disclosure.

FIG. 6A is a graph depicting Fast Fourier Transform (FFT) results of acceleration data corresponding to baseline, in an embodiment of the present disclosure.

FIG. 6B is a graph depicting FFT results of observed acceleration data captured by the accelerometer sensor on an electrolyzer stack, indicating a damaged component, in an embodiment of the present disclosure.

FIG. 7A are graphs depicting the root mean squared (RMS) values of acceleration data (power spectral density (PSD) approach) for—i. normal operation (baseline), and ii. operation in the presence of a damage, in an embodiment of the present disclosure.

FIG. 7B are graphs depicting the mean squared values of FFT results of acceleration data for—i. normal operation (baseline), and ii. operation in the presence of a damage, in an embodiment of the present disclosure.

FIG. 8 is a block diagram illustrating the details of a digital processing system in which various aspects of the present disclosure are operative by execution of appropriate executable modules.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### 1. Overview

Aspects of the present disclosure are directed to an electrolyzer producing hydrogen. According to an aspect, the electrolyzer contains a stack producing a first fluid containing oxygen and a second fluid containing hydrogen upon application of voltage across the stack. A first pipe carries the first fluid away from the stack. A sensor is operable to send vibration signals representing a measure of vibrations of the first pipe when carrying the first fluid away from the stack, and a detection system operates to detect damage to one or more components within the stack based on the vibration signals.

According to another aspect, the stack contains multiple cells, with each cell having a cathode, an anode, and a membrane separating the cathode from the anode, wherein the damage includes a rupture in the membrane in one or more cells of the multiple cells.

According to one more aspect, the sensor is an accelerometer sensor, wherein the accelerometer sensor provides time-domain acceleration magnitudes corresponding to instantaneous vibrations of the first pipe when carrying the first fluid. In an embodiment, the detection system accordingly contains a converter operable to receive vibration signals from the accelerometer sensor and to generate corresponding digital signals, and a digital processor operable to:
generate a baseline characterizing vibration signals for normal operation of the electrolyzer;
   receive digital signals in a current duration;
   compare the digital signals in the current duration with the baseline;
determine whether the comparison indicates damage to one or more components,
wherein if the determination indicates damage to one or more components, the digital processor generates a control signal indicating the damage.

In an embodiment, the membrane is implemented in the form of a polymer electrolyte membrane, wherein the electrolyzer further contains a second pipe to transfer water into the stack, a first control valve operable to open or close the first pipe, and a second control valve operable to open or close the second pipe (with the closing of the valve blocking the corresponding fluid).

According to yet another aspect, the electrolyzer further contains a stack management system operable to perform one or more corrective actions upon receiving the control signal, wherein the corrective actions include, generating an alert, electrically disengaging the stack, and closing the first control valve and/or the second control valve.

Several aspects of the present disclosure are described below with reference to examples for illustration. However, one skilled in the relevant art will recognize that the disclosure can be practiced without one or more of the specific details or with other methods, components, materials and so forth. In other instances, well known structures, materials, or operations are not shown in detail to avoid obscuring the features of the disclosure. Furthermore, the features/aspects described can be practiced in various combinations, though only some of the combinations are described herein for conciseness.

### 2. Example Environment

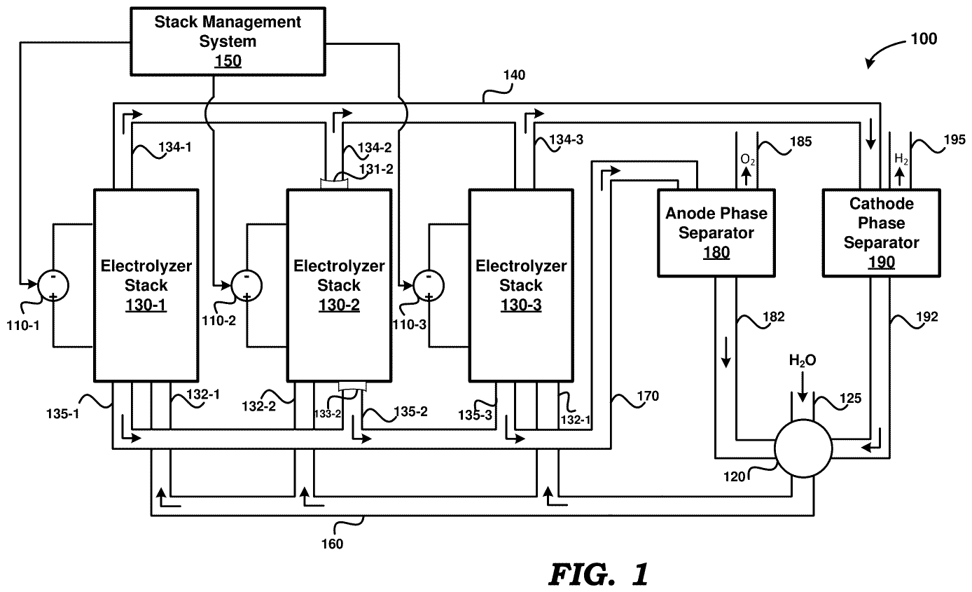

FIG. 1 illustrates an example environment (hydrogen production system) in which several aspects of the present disclosure can be implemented. Specifically, FIG. 1 shows hydrogen production system (electrolyzer) 100 containing power sources 110-1 through 110-3, water pump 120, electrolyzer stacks 130-1 through 130-3, stack management system 150, anode phase separator 180, and cathode phase separator 190. Electrolyzer stacks 130-1 through 130-3 are individually or collectively referred to by numeral 130, as will be clear from the context. Similar convention is used for referring to other components as well.

Merely for illustration, only a representative number of blocks are shown in hydrogen production system 100. Many systems often contain many more electrolyzer stacks (with many electrolyzer cells described below) and other components, depending on the purpose for which the system is designed. Each block of FIG. 1 is described below in further detail.

Each of the electrolyzer stacks 130-1 through 130-3 (collectively referred to as electrolyzer stacks 130) is operatively coupled to a corresponding power source 110-1 through 110-3 (collectively referred to as power sources 110) to produce respective portions of hydrogen gas by way of electrolysis, as described in greater detail below.

In particular, electrolyzer stack 130-2 is shown with subpipe 132-2 from which water is received, oxygen outlet 133-2 and oxygen subpipe 135-2 from which oxygen gas is sent along with water, hydrogen outlet 131-2 and hydrogen subpipe 134-2 from which hydrogen gas is sent also along with water. Though not shown in FIG. 1, electrolyzer stack 130-2 contains a water inlet connecting the stack to subpipe 132-2.

Merely for conciseness subpipes and inlets are shown and described with respect to electrolyzer stack 130-2, though the other stacks would have similar components. It should be further noted that in the following disclosure, the term water refers to either water in liquid form or gas form (water vapor).

Though each stack is described as being powered by a corresponding power source, alternative embodiments may employ a shared power source for all or some of the stacks. The description is continued without some of such details, as not being pertinent to understanding features of the present disclosure.

Common pipe 160 transports water from water pump 120 to each of electrolyzer stacks 130-1 through 130-3. Each subpipe 132 is shown connected between a corresponding water inlet (not shown) of electrolyzer stack 130 and common pipe 160.

Common pipe 140 collects the mixture of hydrogen and water from the respective hydrogen outlets (131) of each electrolyzer stack 130, and transports the same to cathode phase separator 190. Each subpipe 134 is shown connected between hydrogen outlet 131 of a corresponding electrolyzer stack 130 and common pipe 140.

Common pipe 170 collects the mixture of oxygen and water from the respective oxygen outlets (133) of each electrolyzer stack 130, and transports the same to anode phase separator 180. Each subpipe 135 is shown connected between oxygen outlet 133 of a corresponding electrolyzer stack 130 and common pipe 170. Thus, each of subpipes 134 and 135 carry fluids away from (including, out of) electrolyzer stack 130 via respective common pipes 140 and 170.

It should be noted that each subpipe/common pipe shown in hydrogen production system 100 typically has a multi-phase flow that involves the simultaneous movement of one or two distinct phases (here gas and liquid), with these phases interacting at the end points. In particular, the multi-phase flow contains any combination of hydrogen gas, oxygen gas, and water in liquid or vapor form, as would exist then in corresponding subpipes within the electrolyzer stack during operation.

Anode phase separator 180 separates oxygen from the water/oxygen mixture received from pipe 170, and releases the oxygen through output 185. The water separated in the process is released through pipe 182. Cathode phase separator 190 separates hydrogen from the water/hydrogen mixture received from pipe 140, and releases the hydrogen through output 195. The water separated in the process is released through pipe 192. The released hydrogen is dried further before being collected in suitable containers.

Water pump 120 receives water from external source 125 (when starting the electrolysis and for any shortfall of water during electrolysis) and also from pipes 182 and 192, and supplies the requisite water to each of the electrolyzer stacks 130 via pipe 160. The water may be processed for purification, etc., in a known way, before being supplied to electrolyzer stacks 130 via pipe 160.

Stack management system 150 controls various components of FIG. 1 as required for production of hydrogen. Only the connection to power sources 110 is shown for illustration, though stack management system 150 may be connected to other components at least to coordinate the activities of hydrogen production system 100. In one embodiment, stack management system 150 controls the operation of power sources 110 to regulate the voltage and current sent to each of electrolyzer stacks 130. Such power based control may ensure the electrolyzer stacks operates at its peak efficiency, maximizing hydrogen production per unit of electricity consumed. Stack management system 150, anode phase separator 180 and cathode phase separator 190 may be implemented in a known way.

Though not shown in FIG. 1, each electrolyzer stack 130 contains respective fluid control valves that enable opening/closing of oxygen outlet, hydrogen outlet and water inlet and/or controlling flow direction (e.g., via check valves). The opening/closing of valves may be controlled based on corresponding (digital) control signals generated by stack management system 150.

Stack management system 150 may perform one or more corrective action(s) when damage(s) to components within an electrolyzer stack is detected, as will be described in greater detail below. Though not shown in the Figure, stack management system 150 is connected to water pump 120 to control the flow of water to electrolyzer stacks 130.

The description is continued with respect to the details of an electrolyzer stack in one embodiment.

### 3. Electrolyzer Stack

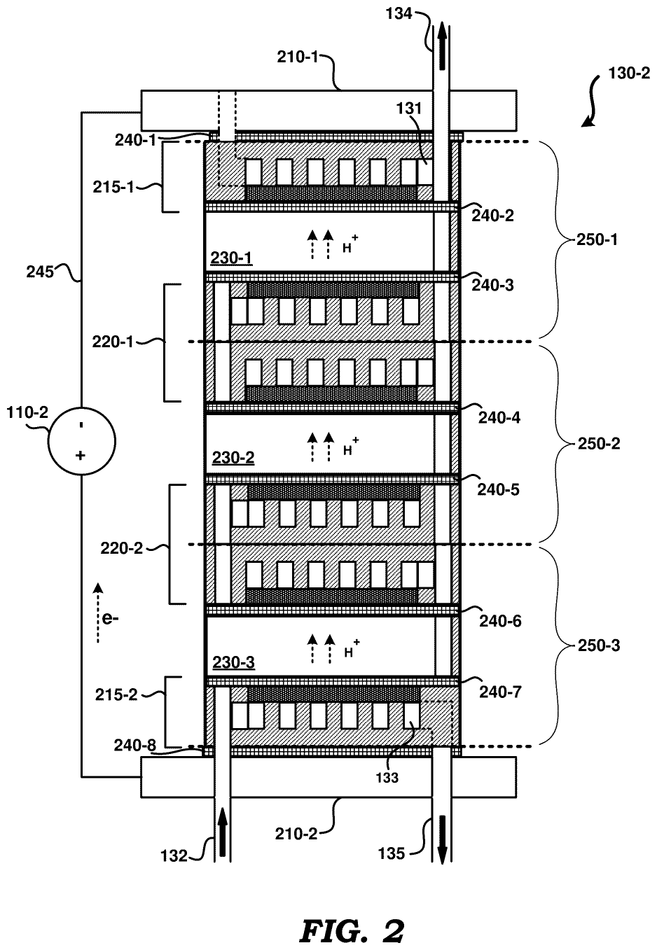

FIG. 2 is a block diagram illustrating the details of an electrolyzer stack 130 in an embodiment. Electrolyzer stack 130 is shown containing three cells 250-1 through 250-3, between end plates 210-1 and 210-2. The three cells are shown realized by monopolar plates 215-1 and 215-2, and bipolar plates 220-1 and 220-2 and membrane electrode assemblies (MEA) 230-1 through 230-3. Also shown in FIG. 2 are sealing components 240-1 through 240-8.

Specifically, cell 250-1 is constituted of monopolar plate 215-1 (acting as cathode), MEA 230-1 and upper side of bipolar plate 220-1 (acting as anode). Cell 250-2 is constituted of lower side of bipolar plate 220-1 (acting as cathode), MEA 230-2 and upper side of bipolar plate 220-2 (acting as anode). Cell 250-3 is constituted of lower side of bipolar plate 220-2 (acting as cathode), MEA 230-3 and monopolar plate 215-2 (acting as anode). However, it may be readily appreciated that the cells can be realized based on monopolar plates (instead of using bipolar plates) alone in alternative embodiments.

Power source 110-2 provides the required potential difference to drive the electrolysis reaction between the anode(s) and the cathode(s) in the stack. Power source 110-2 may provide a current (formed by electrons e−) via external circuit 245. End plates 210-1 and 210-2 provide structural support and electrical connections at the ends of the stack.

Bipolar plates 220-1 and 220-2 separate individual cells in the stack while providing anode and cathode functionality to adjacent cells, as noted above. The plates are also used for distributing water to the anode(s), ensuring electrical connectivity between cells, and facilitating gases (oxygen and hydrogen) and heat transfer. Monopolar plate 215-1 allows hydrogen gas to leave the cathode and monopolar plate 215-2 allows oxygen gas to leave the anode. Bipolar plates 220 and monopolar plates 215 are often made of titanium or other suitable materials for electrolysis, as is well known in the arts.

Sealing components 240-1 through 240-8 are shown located between end plates (210-1 and 210-2) and the adjacent monopolar plates (215-1 and 215-2 respectively), as well as between MEA (230-1, 230-2, and 230-3) and the adjacent bipolar plates (220-1 and 220-2). For example, sealing component 240-1 is shown located between end plate 210-1 and monopolar plate 215-1, sealing component 240-4 is shown located between MEA 230-2 and bipolar plate 220-1, and so on.

Sealing components 240-1 through 240-8 maintain internal pressure of stack 130-2, and prevent leakage of gases (hydrogen and oxygen) and water from stack 130-2. Sealing components 240 are typically made of polymer-based material (e.g., silicone elastomers), and may be implemented in a known way, such as gaskets, O-rings, etc. as is well known in the relevant arts. In an embodiment described herein, sealing components 240-1 through 240-8 are corresponding gaskets. Although sealing components 240 are shown in particular corresponding locations in FIG. 2, the exact placement of sealing components, either next to the end plates or along the membrane periphery, can differ based on the electrolyzer stack design.

MEA 230 enables the electrochemical process that splits water into hydrogen and oxygen, and typically consists of a membrane, catalyst layers, and gas diffusion layers. The thin membrane allows the passage of some charged particles/ions (such as positively charged hydrogen ions/protons) while acting as an insulator for other particles/ions (such as electrons). Catalyst layers are thin layers containing electrocatalysts that facilitate the electrochemical reactions at the anode and cathode. Gas diffusion layers are porous layers that facilitate the transport of gases (oxygen and hydrogen) to and from the catalyst layers.

It may be appreciated that the above noted components may be used to implement different types of electrolysis processes such as Alkaline water electrolysis, Proton Exchange Membrane Electrolysis (PEM), Solid Oxide Electrolysis (SOEC) and Anion Exchange Membrane (AEM) Electrolysis.

In an embodiment described herein, the membrane in MEA 230 is a proton exchange membrane (PEM) which is typically made of a solid polymer electrolyte. PEM allows hydrogen ions (protons), but not electrons, to pass through from anode(s) to cathode(s). PEM electrolysis employs noble metal catalysts, typically using Iridium (IrO2) at the anode and platinum (Pt black) at the cathode.

Thus, each of cells 250 represents a single PEM cell that performs the splitting of water into hydrogen and oxygen. The operational view of a single PEM cell is described next.

### 4. PEM Electrolyzer Cell

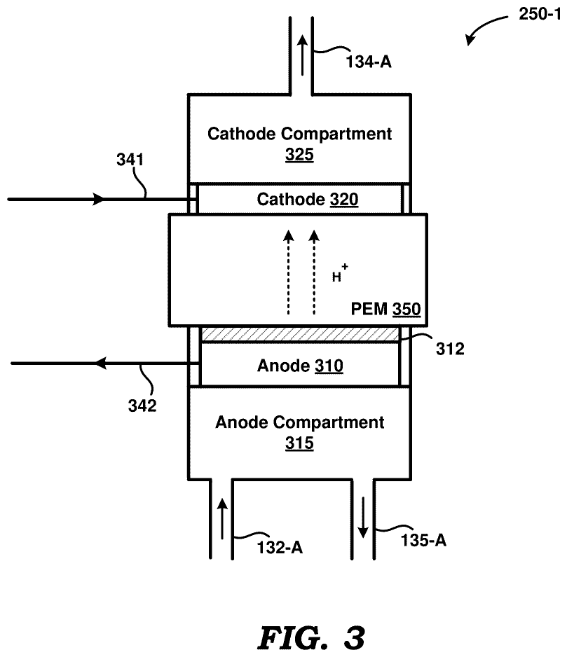

FIG. 3 is a block diagram illustrating the details of Proton Exchange Membrane (PEM) electrolyzer cell in an embodiment. PEM electrolyzer cell 250-1 is shown containing anode 310 (incorporating anode catalyst 312), anode compartment 315, cathode 320, cathode compartment 325, PEM 350, electrical connections 341 and 342 (driven by power source 110-2), water subpipe 132-A, oxygen subpipe 135-A and hydrogen subpipe 134-A. Each block of FIG. 3 is described below in further detail.

Water inlet 132-A, water and oxygen outlet 135-A, and hydrogen outlet 134-A logically represent the respective conduits for the individual PEM electrolyzer cell 250-1, and would thus be operationally part of subpipes 132, 135 and 134 respectively.

At anode compartment 315, water (H2O) is received via subpipe 132-A (a part of 132). Within anode compartment 315, anode 310 facilitates oxidation of the water molecules, thereby splitting the water molecules into protons (H⁺ ions), electrons (e⁻), and oxygen gas (O₂). Also, it is noted that the oxygen gas generated at anode 310 is a byproduct of PEM electrolyzer cell 250-1.

Catalyst 312 increases the oxidation of water molecules at anode 310 and/or lowers the energy requirements for such oxidation, as is well known in the arts. Catalyst 312 is typically composed of metal-oxide based catalysts such as iridium oxide (IrO₂), ruthenium oxide (RuO₂), or iridium ruthenium oxide (IrRuOx). Electrons generated at anode 310 are directed through an external circuit (provided via electrical connections 341 and 342) to cathode 320.

PEM 350 allows only protons to pass through, preventing gas mixing between the anode compartment 315 and cathode compartment 325. Cathode 320 combines protons with electrons to form hydrogen gas (H₂), which exits the cathode compartment 325 through subpipe 134-A (a part of 134). Simultaneously, a gas mixture composed of oxygen gas generated at anode 310, trace amounts of hydrogen gas due to crossover through the PEM 350, and water is sent out via subpipe 135-A (part of 135).

Electrical connections 341 and 342 (driven by power source 110-2) provide the required potential difference to drive the electrolysis reaction between anode 310 and cathode 320. Thus, PEM electrolyzer cell 250-1 is designed to operate as part of an electrochemical system designed to produce hydrogen gas (H₂) through water electrolysis.

It is noted herein that in the following disclosure, the term “electrolyzer” represents any of a hydrogen production system (such as 100 of FIG. 1), an electrolyzer stack (such as 130-2 of FIG. 2) or an electrolyzer cell (such as PEM cell 250-1 of FIG. 3).

As noted in the background, there may be damages to components within electrolyzer stack 130-2. For example, there may be rupture in PEM 350 in one or more cells 250, rupture in sealing components 240, etc. Rupture in PEM 350 may lead to hydrogen gas rushing over to subpipe 135-A and mixing with oxygen, resulting in possible risk of ignition and/or explosion. Similarly, a rupture in sealing component also may cause similar risk.

Accordingly, it is desirable to detect such damages during operation of the electrolyzer. Aspects of the present disclosure detect damage to components within an electrolyzer during operation as described below with examples.

### 5. Detection of Damages Using Accelerometer Sensor

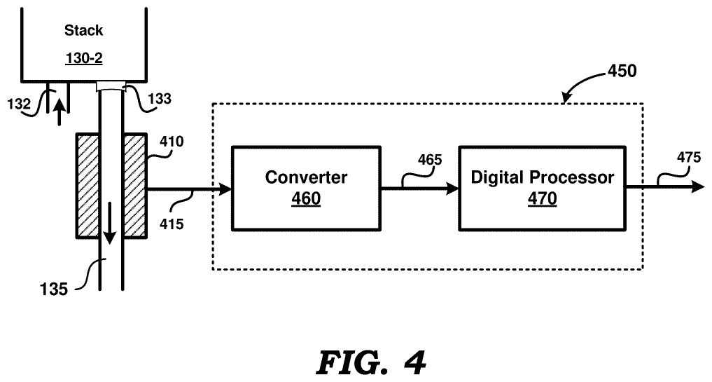

FIG. 4 is a block diagram illustrating the details of an example implementation using which damage to components within hydrogen production system 100 can be detected according to aspects of the present disclosure. The block diagram is shown containing accelerometer sensor 410 mounted on subpipe 135 of stack 130-2 in combination with detection system 450. Detection system 450 in turn is shown containing converter 460 and digital processor 470.

Accelerometer sensor 410 generates signals (on path 415) representing time-domain acceleration magnitudes corresponding to the instantaneous vibrations of subpipe 135. It should be appreciated that the vibrations result generally due to multi-phase flow of oxygen, hydrogen (potentially only traces during normal operation and significantly more in case of damage to components, as described herein) and water moving through anode outlet 133 and subpipe 135, and in particular due to the impact of the flow against the internal walls of subpipe 135. The output of accelerometer sensor 410 is accordingly generally referred to as vibration signals. Thus, the vibration signals represent a measure of vibrations of subpipe 135 when carrying the multi-phase flow away from the electrolyzer stack.

In an embodiment, accelerometer sensor 410 is realized using LIS3DH ultra-low-power high-performance three-axis linear accelerometer, available from STMicroelectronics NV, 7500 Viscount Ave, Suite 292, EL PASO, Texas 79925-569. Although a three-axis accelerometer is employed in the illustrative embodiment, it may be appreciated that other types of (e.g., 3 single-axis) accelerometers (located suitably) may be employed in alternative embodiments, as will be apparent to a skilled practitioner by reading the disclosure provided herein.

Detection system 450 examines the vibration signals received on path 415 to detect damage to any components within electrolyzer stack (130-2). Detection system 450 needs to be implemented consistent with the form/format of vibration signals generated by accelerometer sensor 410. Though not shown, detection system 450 may receive vibration signals from corresponding accelerometer sensors placed for detection of damages to components within any/all electrolyzer stacks.

In an embodiment, accelerometer sensor 410 generates vibration signals in analog form on path 415, and accordingly detection system 450 is shown including converter 460 and digital processor 470.

Converter 460 converts the analog signals representing the vibrations to digital signals and forwards the resulting digital data elements to digital processor 470 via path 465. Digital processor 470 processes the digital data elements received on path 465 to detect damage to any components in electrolyzer stack 130-2.

In another embodiment, the vibration signals generated by accelerometer sensor 410 are in digital form. In such an embodiment, converter 460 is omitted from detection system 450, and the digital output signals from accelerometer sensor 410 are transmitted directly to digital processor 470.

Though not shown in the Figure, additional hardware, such as low-pass filters, and/or software-based digital signal processing techniques can be implemented to enhance the signal-to-noise ratio of and filter unwanted noise in the output of accelerometer sensor 410, as will be apparent to a skilled practitioner.

Digital processor 470 may also generate control signals on path 475 to control the operation of (to change internal status of) various components in electrolyzer stack 130-2, in addition to providing alerts according to a suitable interface. In an embodiment, the control signals operate in conjunction with stack management system 150, to perform any corrective action(s) (e.g., shutting down the specific stack that is detected to have a damaged component, opening/close the valves to control the fluid flow), as described in further detail below. Though not shown, path 475 extends to stack management system 150.

It may be appreciated that mounting accelerometer sensor 140 on subpipe 135 of the electrolyzer stack may provide several advantages. Specifically, such a location may capture vibrational or flow-related disturbances resulting from damage to components within the stack early on (immediately upon or shortly after the occurrence of the damage).

For example, if a sealing component (240) fails or a membrane (350) ruptures, hydrogen may crossover into subpipe 135, altering the flow dynamics and pressure, and produce (almost) instantaneous detectable changes in vibrations that are captured by accelerometer sensor 140 mounted on subpipe 135. As a result, mounting the sensor on subpipe 135 may allow reliable and timely detection of damages.

The description is continued with respect to the manner in which detection system 450 can detect damage to components using the vibration signals received from accelerometer sensor 410.

### 6. Detecting Damage to Components within an Electrolyzer During Operation

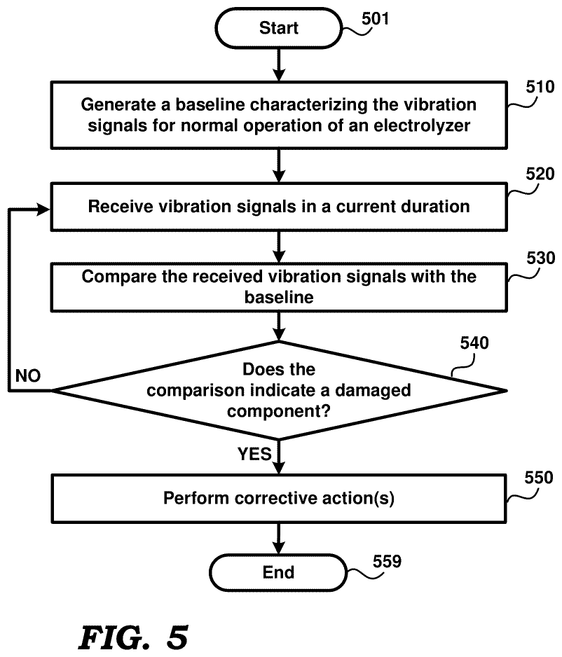

FIG. 5 is a flow chart illustrating the manner in which damage to components within an electrolyzer stack is detected during operation, according to several aspects of the present disclosure. The flow chart is described with respect to the systems/components of FIGS. 1, 2, 3 and 4, merely for illustration. However, many of the features can be implemented in other environments or configurations also without departing from the scope and spirit of several aspects of the present invention, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present invention. The flow chart begins in step 501, in which control immediately passes to step 510.

In step 510, detection system 450 generates a baseline characterizing the vibration signals captured by accelerometer sensor 410 (more specifically at the position of accelerometer sensor 410) for normal operation of electrolyzer stack 130-2. As may be readily appreciated, during normal operation, all internal components of electrolyzer stack 130-2 operate within parameters as designed, implying a conclusion that there is no damage to components internal to electrolyzer stack 130-2.

Detection system 450 may employ any of various well-known techniques to generate a baseline characterizing the vibration signals for normal operation. The baseline captures the patterns of vibrations in forms such as equations and amplitudes in frequency domain, that lend to comparison with other patterns of vibrations, as described below.

In step 520, detection system 450 receives vibrations signals as input from accelerometer sensor 410 in a current duration. Current duration implies that the inputs are received concurrent with the operation of hydrogen production system 100. In the embodiment depicted in FIG. 4, the input can be in the form of digital elements representing time-domain acceleration magnitudes corresponding to the instantaneous vibrations of subpipe 135.

In step 530, detection system 450 compares the vibration signals received in step 520 with the baseline determined in step 510. In step 540, detection system 450 determines whether the comparison between the input and the baseline indicates the presence of a damaged component within electrolyzer stack 130-2. The combination of comparison and determination can be based on any of various techniques (e.g., based on AI/ML), as will be apparent to a skilled practitioner based on the disclosure provided herein. Examples include, but not limited to, feature extraction using frequency domain methods (e.g., Fourier transform) and further inference using deep neural networks or simpler approaches such as support vector machines.

An example mathematical approach for such comparison and determination is described in detail below. Control passes to step 520 for continued operational monitoring if there no damage is determined and to step 550 if a damage is deemed to be present.

In step 550, one or more corrective actions are performed by sending corresponding signals. For example, stack management system 150 sends signals to shut off the corresponding power source (e.g., 110-1, 110-2, or 110-3), close one or more fluid control valves associated with electrolyzer stack (e.g., 130-1, 130-2, or 130-3), and/or disable the water pump (e.g., 120) connected to the affected electrolyzer stack.

The affected stack is thus effectively isolated from the rest of hydrogen production system 100. In addition, the control signal may generate alerts to be transmitted to an external system/component to initiate further action by human operators.

While accelerometer sensor 410 is described as being mounted on subpipe 135, it should be appreciated that accelerometer sensor 410 can be located/positioned in various other positions. For example, accelerometer sensor 410 may alternatively be mounted on other pipes, such as common pipe 170, to measure composite vibration resulting from multi-phase flow conditions across multiple stacks. As another example, accelerometer sensor 410 may be placed directly on a stack, to measure composite vibration resulting from multi-phase flow conditions across all ports on the stack.

Such placements/configurations enable detection of abnormalities at a hydrogen production system-wide level or on a per-stack basis. The vibration signals sent by accelerometer sensor 410 reflect the altered vibrations, and detection system 450 processes the corresponding signal parameters to confirm the presence of damage within electrolyzer stack 130-2 as described above with respect to FIG. 5.

It may be appreciated that multi-phase flows through subpipe 135 during normal operation and in the presence of damaged components may result in/manifest as corresponding different characteristics (pattern) of the vibration signals (e.g., magnitude of acceleration along x/y/z-axis) captured by accelerometer sensor 410.

Specifically, during normal operation of electrolyzer stack 130, subpipe 135 carries a multi-phase flow composed primarily of oxygen gas (O₂) and water, and trace amounts of hydrogen gas (H2) where the water may be in liquid or vapor form depending on temperature and pressure conditions. However, damage to components (e.g., a rupture in membrane 350) may lead to hydrogen crossover to the anode, and accordingly, the composition and flow characteristics of multi-phase flow through subpipe 135 may be different from those during normal operation of stack 130. Thus, during normal operation, subpipe 135 may carry a turbulent slug flow, for example, and due to damage to components, the flow may become more turbulent.

Such differences manifest as corresponding change(s) in the pattern of the vibration signals captured by accelerometer sensor 410. The change(s) in pattern may be used by detection system 450 as the basis for detecting the damage during operation of electrolyzer stack 130, as described next.

### 7. Generating Baseline

According to an aspect, detection system 450 generates a baseline characterizing the vibration signals captured by accelerometer sensor 410 for normal operation of electrolyzer stack 130. As noted above, the baseline captures the patterns of vibrations in forms such as equations, that lend to comparison with other patterns of vibrations.

It may be appreciated that the baseline may be generated in a controlled environment (e.g., a laboratory) or during regular operation (concurrent with the operation of hydrogen production system 100 to actively generate hydrogen). While the controlled environment needs to simulate real-world operation for an accurate baseline, during regular operation, the baseline parameters can be determined when no problems are normally perceived.

According to an aspect, digital processor 470 transforms time-domain based digital signals received on path 465 to frequency domain, representing amplitude and phase of vibrations of the multi-phase flow at discrete frequencies. Specifically, digital processor 470 performs Fast Fourier Transform (FFT) of digital signals for such transformation. Thereafter, digital processor 470 generates a baseline based on the FFT results.

In one embodiment, digital processor 470 performs the FFT of digital signals for an electrolyzer stack for each time duration of multiple distinct (non-overlapping) time durations, and computes an average of the FFT results across time durations at corresponding frequencies in order to generate the baseline for that stack. Thus, each data point in the baseline FFT results represents an amplitude of vibration signals at a corresponding frequency.

Alternatively, or in addition, for a particular time duration, digital processor 470 may perform FFT of digital signals received from one or more electrolyzer stacks 130, and compute an average of the FFT results in order to generate a common baseline for all stacks in electrolyzer 100. The baseline may include FFT results for each of x, y and z axes, and/or may include an overall vibration level (FFT results for a combined signal representing vector magnitude of the vibration signals), as will be apparent to a skilled practitioner by reading the disclosure provided herein.

It may be appreciated that stacks having similar characteristics and designed to operate under similar operating conditions may be configured with a common baseline (generated for one representative stack). Alternatively, a respective baseline may be generated for each electrolyzer stack.

In an embodiment, digital processor 470 generates the following baseline parameters:

i. FFT Result of Digital Signals (Received on Path 465);

Digital processor 470 collects signals received on path 465 for normal operation of electrolyzer stack 130 for a set of time durations. Digital signals 465 correspond to discrete values of vibration signals representing acceleration in each of x, y and z axes. Digital processor 470 performs FFT of digital signals for each time duration of the set of time durations to generate a corresponding set of FFT results (one FFT result corresponding to each time duration). As is well known in the relevant arts, each FFT result includes a set of frequencies and a corresponding amplitude at each frequency.

In an embodiment, for each time duration, digital processor 470 generates FFT results for each of x, y and z axes. Digital processor 470 then calculates a corresponding average for each frequency in the FFT results, with the corresponding average being an average of respective amplitudes for the frequency in corresponding FFT result. The calculated average values at corresponding frequencies constitute the baseline FFT result.

Alternatively, or in addition, digital processor 470 may compute xyz acceleration vector magnitudes for each time duration, perform FFT of the vector magnitudes for each time duration, and compute average values of the FFT results (at corresponding discrete frequencies) to generate the baseline, as will be apparent to a skilled practitioner.

ii. Root Mean Square (RMS) of Digital Signals (Received on Path 465) Computed Via Power Spectral Density (PSD);

As is well known in the relevant arts, the PSD of a signal provides information on the distribution of signal power across frequencies. In other words, PSD indicates how “strong” or “energetic” the signal is at each frequency.

In an embodiment, the process to calculate RMS includes performing FFT of digital signals for a time duration, and calculating root mean square of power spectral density of the FFT result for that duration. Equation (1) below summarizes the above approach:

$$RMS = \sqrt{( {\sum }_{i = 1}^{n} {X}_{i}^{2} ) \div n} \qquad Equation ( 1 )$$

where ‘n’ is the number of samples in the time duration, Xᵢ is the FFT value of the i^{th} sample.

RMS values may be computed for a set of time durations (e.g., 3-5 time durations of substantially equal length), and an average of the RMS values is calculated. Baseline parameter, RMS-bl, equals the average RMS.

iii. Mean-Square (Average of all Squared Magnitudes) of the FFT Results of Digital Signals (Received on Path 465):

In an embodiment, the process of calculating mean-square includes performing FFT of digital signals (xyz acceleration vector magnitude) for a time duration, and computing the mean square of amplitudes in the FFT result. Equation (2) below summarizes the above approach:

$$Mean - Square = ( {\sum }_{i = 1}^{n} {X}_{i}^{2} ) \div n \qquad Equation ( 2 )$$

where ‘n’ is the number of samples in the time duration, Xᵢ is the FFT value of the i^{th} sample.

Mean-Square values may be computed for a set of time durations (e.g., 3-5 time durations of substantially equal length), and an average of the mean-square values is calculated. Baseline parameter, MS-bl, equals the average mean-square.

Thus, using equations (1) and (2) noted above, digital processor 470 generates baseline parameters RMS-bl and MS-bl respectively for characterizing the vibration signals for normal operation of an electrolyzer. The baseline parameters may be stored in a non-volatile memory (not shown), and retrieved by digital processor 470 in a known way.

The baseline may be normalized/calibrated based on system parameters specific to the hydrogen production system, such as water usage, oxygen production rate, the type of stack being used, the material composition/geometry of stack 130 and subpipe 135, etc., as will be apparent to a skilled practitioner by reading the disclosure herein.

The description is continued to illustrate the manner in which detection system 450 uses the generated baseline to detect damage to components within an electrolyzer stack during operation.

### 8. Detection of Damage to Components

According to an aspect, during operation of hydrogen production system 100, detection system 450 receives vibration signals from accelerometer sensor 410 in a current duration and compares the received vibration signals with the baseline to detect damage to component(s) within electrolyzer stack 130.

Detection system 450 may continuously receive vibration signals captured by accelerometer sensor 410, and may perform the detection based on vibration signals corresponding to discrete time durations. Alternatively, more complex sliding window-based detection mechanisms also can be employed, as will be apparent to a skilled practitioner based on the disclosure provided herein. The time window for which the computations are performed, may be viewed as the current time duration.

In an embodiment, digital processor 470 performs FFT of the digital signals (received on path 465) in the current time duration, and computes RMS value and mean-square value of the observed FFT results (respectively using equations (1) and (2) noted above). As may be appreciated, these represent single-value thresholds for the baseline. However, the baseline may be extended to also examine corresponding patterns (e.g., discrete FFT results) for detection of damaged components.

In an embodiment, digital processor 470 determines the presence of a damaged component within electrolyzer stack based on one or more of the following comparisons:
1. Digital processor 470 compares baseline discrete FFT results with (observed) discrete FFT results of vibration signals in the current time duration. If a damage is present, certain frequency components may present themselves as significantly higher in magnitude (amplitude) compared to the baseline magnitude for the corresponding frequencies. If one or more amplitudes in observed FFT results exceed those in the baseline FFT results for corresponding frequencies, digital processor 470 concludes the presence of a damaged component within electrolyzer stack 130.
2. Digital processor 470 compares baseline RMS value (RMS-bl) with computed RMS value of vibration signals in the current time duration. If the computed RMS value of vibration signals in the current time duration exceeds RMS-bl, digital processor 470 concludes the presence of a damaged component within electrolyzer stack 130.
3. Digital processor 470 compares baseline mean-square value (MS-bl) with computed mean-square value of vibration signals in the time current duration. If the computed mean-square value of vibration signals in the current time duration exceeds MS-bl, digital processor 470 concludes the presence of a damaged component within electrolyzer stack 130.

While digital processor 470 is described as analyzing observed values from the accelerometer, it should be appreciated that various other parameters can also be examined in combination in determining presence of any damaged components. Examples of such other parameters include system controls (the voltage applied to the stack, in addition to stack specifications that include the number of cells, active area size, etc.), and other system measurements (current and voltage through a stack, flow meter readings), etc.

Upon detecting a damage, digital processor 470 generates a control signal on path 475 to indicate the damage. In an embodiment, control signal (475) controls the operation of (to change internal status of) various components in electrolyzer stack 130-2, in addition to providing alerts according to a suitable interface.

In response to receipt of control signal, stack management system 150 may perform one or more corrective action(s) such as shutting down power to (electrically disengaging) the specific stack that is detected to have a damaged component, closing one or more fluid control valves of the affected stack, disabling the water pump (e.g., 120) connected to the affected electrolyzer stack, etc. Stack management system 150 may perform such corrective actions by sending appropriate commands to the corresponding components in a known way.

While the illustrative embodiment describes signal 475 as controlling the operation of various components in conjunction with stack management system 150, in an alternative embodiment, the signal generated on path 475 may only notify a damage, and the intelligence of controlling the operation of various components may be embedded within stack management system 150.

It may be appreciated that in order to conservatively avoid false positives (i.e., indications of damage when an actual damage is not present in electrolyzer stack 130), digital processor 470 may indicate that a damage is detected only when each of the above observed values (in current duration) exceeds the respective thresholds by a corresponding pre-determined percentage margin. The margins may be specified by end user (via corresponding means not shown) or may be configured in non-volatile memory in a known way.

Alternatively, or in addition, digital processor 470 may indicate a damage only when the thresholds are exceeded in a pre-determined percentage of consecutive observations (e.g., 6 out of 10 consecutive observations). Such an approach may ensure that transient fluctuations or sensor noise do not trigger false positives, while still reliably detecting sustained abnormal behavior.

It may also be appreciated that the baseline parameters may be re-generated to account for changes in patterns of vibration signals for normal operation resulting from changes in environmental conditions, sensor characteristics, wear and tear, etc. The re-generation may be periodic/adaptive/conditional. Such re-generation may ensure that threshold-based detection remains accurate without triggering false positives.

Although the illustrative embodiment describes discrete FFT results, RMS and mean-square values as constituting the baseline, it may be appreciated that more complex statistical models employing alternative deviation measures, and/or AI/ML techniques may be employed to generate the baseline. Further, although the illustrative embodiment employs pattern-based and threshold-based comparisons to detect damage(s), it may be appreciated that distribution-based/forecasting-based/rule-based detection approaches may be employed, as will be apparent to a skilled practitioner by reading the disclosure herein.

The description is continued to illustrate baseline patterns/values for normal operation and observed patterns/values in the presence of damage within electrolyzer stack 130, in an embodiment of the present disclosure.

### 9. Example Graphs Corresponding to Normal Operation and Operation in the Presence of Damaged Component(s)

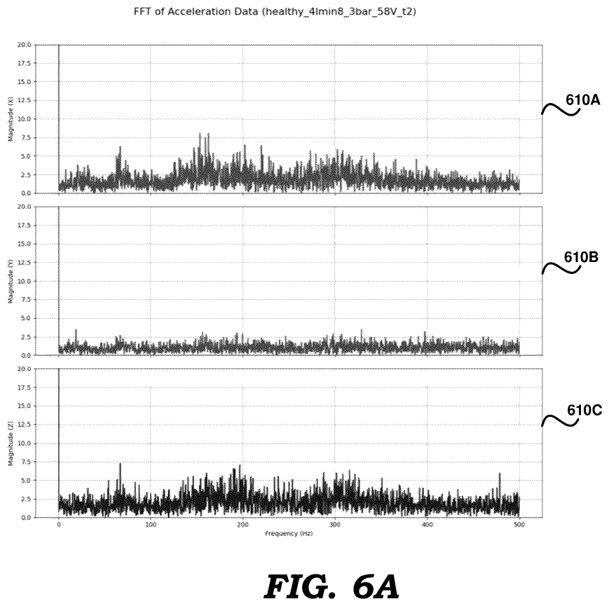

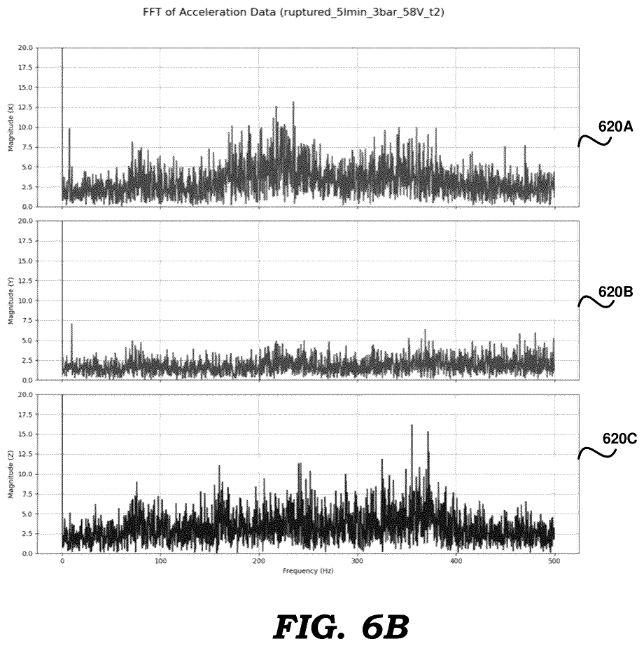

FIG. 6A is a graph depicting baseline FFT results of vibration signals captured by accelerometer sensor 410 for normal operation, in an embodiment of the present disclosure. FIG. 6A is shown containing FFT results 610A, 610B and 610C, representing the result of performing FFT on vibration signals received for each of x, y and z axes respectively with the operating parameters configured to: Flow Rate: 4.8 L/min, Stack Pressure: 3 bar, Stack Voltage: 58V, for a time duration ‘t2’.

FIG. 6B is a graph shown containing sample observed FFT results 620A, 620B and 620C, representing the result of performing FFT on vibration signals received for each of x, y and z axes respectively during operation of electrolyzer stack 130 in the presence of a rupture to membrane 350, for a time duration ‘t2’. It may be observed that the most variance in acceleration is manifested along x and z axes.

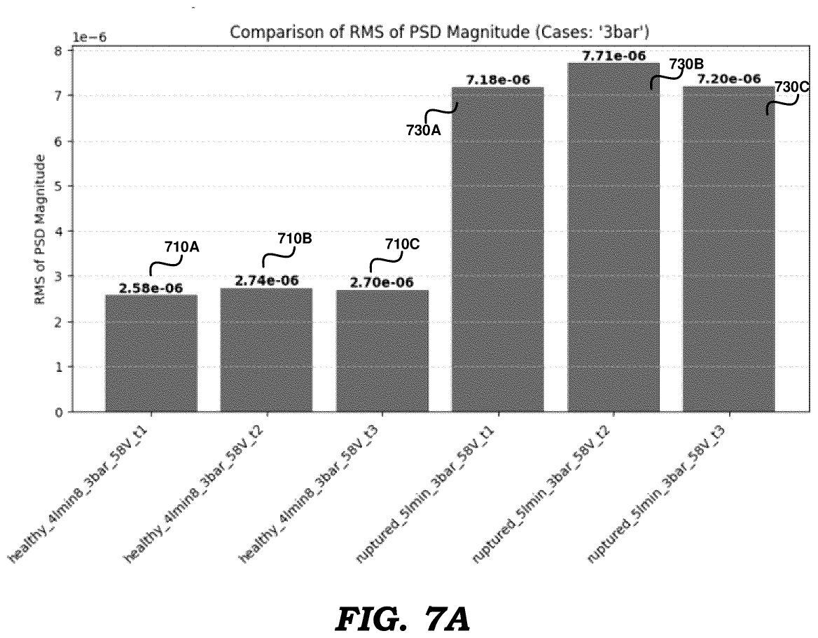

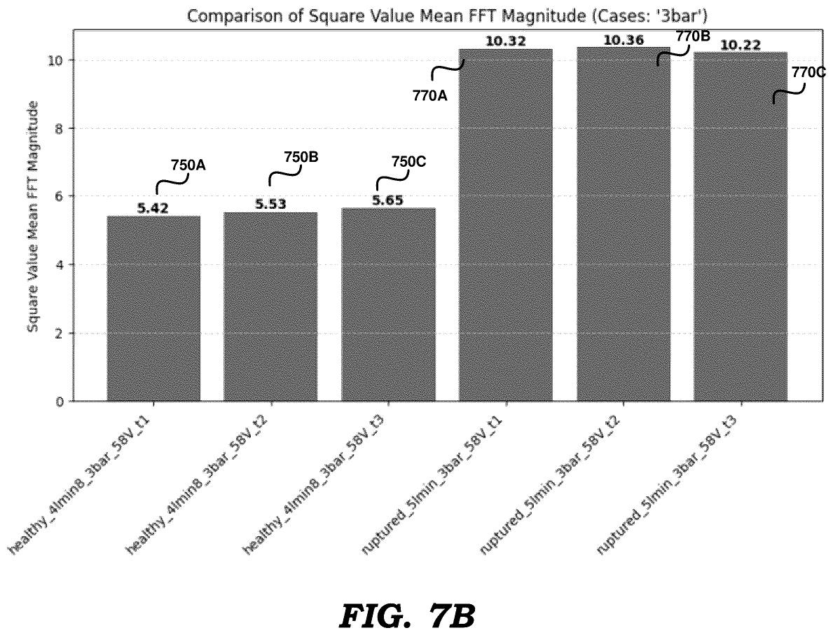

FIG. 7A depicts baseline and observed RMS values in a graphical form. Values 710A, 710B and 710C depict baseline RMS values (computed via PSD approach noted above) for three time durations t1, t2 and t3 respectively, while values 730A, 730B and 730C depict sample observed RMS values for current durations t1, t2 and t3 (of substantially similar lengths as those of time durations used to generate baseline) in the presence of a rupture to membrane 350. The threshold RMS (RMS-bl) may be computed as the average of values 710A, 710B and 710C.

FIG. 7B depicts baseline and observed mean-square values in a graphical form. Values 750A, 750B and 750C depict baseline mean-square values for three time durations t1, t2 and t3 respectively, while values 770A, 770B and 770C depict sample observed mean-square values for current durations t1, t2 and t3 (of substantially similar lengths as those of time durations used to generate baseline) in the presence of a rupture to membrane 350. The threshold mean-square (MS-bl) may be computed as the average of values 750A, 750B and 750C.

Thus, aspects of the present disclosure provide detection of damage to components within an electrolyzer stack during operation. It may be appreciated that identifying failed stacks in a modular multi-stack electrolyzer configuration may enhance troubleshooting efficiency by isolating the faulty stack and streamlining maintenance procedures. In addition, such isolation may ensure continued operation of the remaining stacks at reduced capacity, maintaining system functionality and output while minimizing downtime.

It should be further appreciated that the features described above can be implemented in various embodiments as a desired combination of one or more of hardware, software, and firmware. The description is continued with respect to an embodiment in which various features are operative when the software instructions described above are executed.

### 10. Digital Processing System

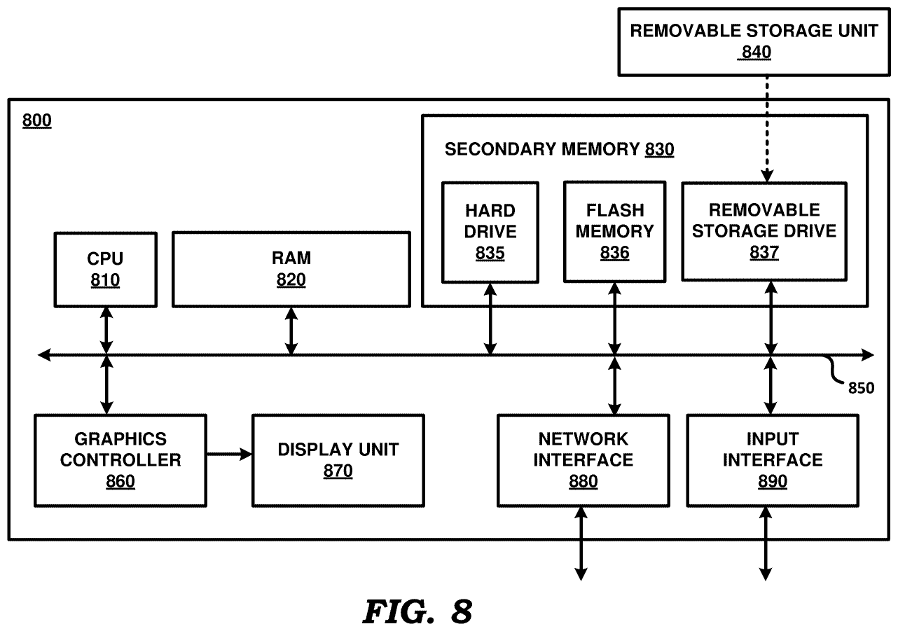

FIG. 8 is a block diagram illustrating the details of digital processing system 800 in which various aspects of the present disclosure are operative by execution of appropriate executable modules. Digital processing system 800 may correspond to digital processor 470 of FIG. 4.

Digital processing system 800 may contain one or more processors such as a central processing unit (CPU) 810, random access memory (RAM) 820, secondary memory 830, graphics controller 860, display unit 870, network interface 880, and input interface 890. All the components except display unit 870 may communicate with each other over communication path 850, which may contain several buses as is well known in the relevant arts. The components of FIG. 8 are described below in further detail.

CPU 810 may execute instructions stored in RAM 820 to provide several features of the present disclosure. CPU 810 may contain multiple processing units, with each processing unit potentially being designed for a specific task. Alternatively, CPU 810 may contain only a single general-purpose processing unit.

RAM 820 may receive instructions from secondary memory 830 using communication path 850. RAM 820 may contain software instructions constituting a shared environment and/or other user programs (such as other applications, DBMS, etc.). In addition to shared environment, RAM 820 may contain other software programs such as device drivers, virtual machines, etc., which provide a (common) run time environment for execution of other/user programs.

Graphics controller 860 generates display signals (e.g., in RGB format) to display unit 870 based on data/instructions received from CPU 810. Display unit 870 contains a display screen to display the images defined by the display signals. Input interface 890 may correspond to a keyboard and a pointing device (e.g., touch-pad, mouse) and may be used to provide inputs. Network interface 880 provides connectivity to a network (e.g., using Internet Protocol), and may be used to communicate with other systems connected to the networks.

Secondary memory 830 may contain hard drive 835, flash memory 836, and removable storage drive 837. Secondary memory 830 may store the data (e.g., measurements, determined amount of oxygen, calculated amount of air to be injected, etc.) and software instructions (for implementing the features of the disclosure, implementing some of the blocks of FIG. 4), which enable digital processing system 800 to provide several features in accordance with the present disclosure. The code/instructions stored in secondary memory 830 may either be copied to RAM 820 prior to execution by CPU 810 for higher execution speeds, or may be directly executed by CPU 810.

Some or all of the data and instructions may be provided on removable storage unit 840, and the data and instructions may be read and provided by removable storage drive 837 to CPU 810. Removable storage unit 840 may be implemented using medium and storage format compatible with removable storage drive 837 such that removable storage drive 837 can read the data and instructions. Thus, removable storage unit 840 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 840 or hard disk installed in hard drive 835. These computer program products are means for providing software to digital processing system 800. CPU 810 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 830. Volatile media includes dynamic memory, such as RAM 820. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 850. Transmission media can also take the form of acoustic or light waves, such as those generated during radio-wave and infra-red data communications.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

### 11. Conclusion

While various embodiments of the present disclosure have been described above, it should be understood that they have been presented by way of example only, and not limitation. Thus, the breadth and scope of the present disclosure should not be limited by any of the above-described exemplary embodiments, but should be defined only in accordance with the following claims and their equivalents.

It should be understood that the figures and/or screen shots illustrated in the attachments highlighting the functionality and advantages of the present disclosure are presented for example purposes only. The present disclosure is sufficiently flexible and configurable, such that it may be utilized in ways other than that shown in the accompanying figures.

Further, the purpose of the following Abstract is to enable the Patent Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present disclosure in any way.

What is claimed is:

1. An electrolyzer for producing hydrogen, said electrolyzer comprising:
a stack producing a first fluid containing oxygen and a second fluid containing hydrogen upon application of voltage across said stack;
a first pipe to carry said first fluid away from said stack; and
a sensor operable to send vibration signals representing a measure of vibrations of said first pipe when carrying said first fluid away from said stack,
wherein a detection system operates to detect damage to one or more components within said stack based on said vibration signals.

2. The electrolyzer of claim 1, wherein said stack comprises:
a plurality of cells, each cell having a cathode, an anode, and a membrane separating said cathode from said anode,
wherein said damage includes a rupture in said membrane in one or more cells of said plurality of cells.

3. The electrolyzer of claim 1, wherein said sensor comprises an accelerometer sensor, wherein said accelerometer sensor provides time-domain acceleration magnitudes corresponding to instantaneous vibrations of said first pipe when carrying said first fluid.

4. The electrolyzer of claim 3, wherein said detection system comprises:
a converter operable to receive vibration signals from said accelerometer sensor and to generate corresponding digital signals; and
a digital processor operable to:
generate a baseline characterizing vibration signals for normal operation of said electrolyzer;
receive digital signals representing vibration signals in a current duration;
compare said digital signals received in said current duration with said baseline;
determine whether said comparison indicates damage to one or more components,
wherein if said determination indicates damage to one or more components, said digital processor generates a control signal indicating said damage.

5. The electrolyzer of claim 4, wherein said membrane comprises a polymer electrolyte membrane, wherein said electrolyzer further comprises:
a second pipe to transfer water into said stack;
a first control valve operable to open or close said first pipe; and
a second control valve operable to open or close said second pipe.

6. The electrolyzer of claim 5, wherein said electrolyzer further comprises a stack management system operable to perform one or more corrective actions upon receiving said control signal, wherein said corrective actions include:
generating an alert;
electrically disengaging said stack; and
closing said first control valve and/or said second control valve.

7. The electrolyzer of claim 4, wherein said stack further comprises a plurality of sealing components, wherein said damage includes a rupture in one or more of said sealing components.

8. The electrolyzer of claim 4, wherein to generate said baseline, said digital processor is configured to:
sample digital signals representing vibration signals in a set of time durations of normal operation of said electrolyzer;
perform Fast Fourier Transform (FFT) of said sampled digital signals for each time duration of said set of time durations to generate a corresponding set of FFT results, each FFT result including a set of frequencies and a corresponding amplitude at each frequency;
calculate a corresponding average for each frequency of said set of frequencies, the corresponding average being an average of respective amplitudes for the frequency in corresponding FFT result, the corresponding averages and said set of frequencies constituting a baseline-FFT-result;
compute a corresponding root mean square of power spectral density of each FFT result of said set of FFT results, and then an average of the root mean square values as a first threshold; and
calculate a corresponding mean square of amplitudes in each FFT result of said set of FFT results, and then an average of the mean square values as a second threshold,
wherein said baseline-FFT-result, said first threshold and said second threshold together constitute said baseline.

9. The electrolyzer of claim 8, wherein to compare said digital signals in said current duration with said baseline, said digital processor is configured to:
perform FFT of said digital signals received in said current duration to generate an observed-FFT-result, said observed-FFT-result including said set of frequencies and a corresponding observed-amplitude at each frequency of said set of frequencies;
compute a set of difference-amplitudes with each difference-amplitude of said set of difference-amplitudes being a difference between the observed-amplitude and the corresponding average of said baseline-FFT-result at a corresponding frequency of said set of frequencies,
wherein said digital processor concludes damage to one or more components based on said set of difference-amplitudes.

10. The electrolyzer of claim 9, wherein said digital processor is further operable to:
compute a root mean square of power spectral density of said observed-FFT-result as an observed-RMS;
calculate a mean square of amplitudes in said observed-FFT-result as an observed-MS,
wherein said digital processor concludes damage to one or more components based on a difference between said observed-RMS and said first threshold and/or a difference between said observed-MS and said second threshold.

11. An electrolyzer for producing hydrogen, said electrolyzer comprising:
a plurality of cells with each cell containing a corresponding anode and a corresponding cathode, each cell of said plurality of cells producing a first fluid containing oxygen at said corresponding anode and a second fluid containing hydrogen at said corresponding cathode upon application of voltage across said cell;
an anode phase separator;
a first pipe to collect said first fluid for transferring to said anode phase separator, wherein said anode phase separator operates to separate oxygen from said first fluid; and
a sensor operable to send vibration signals representing a measure of vibrations of said first pipe when carrying said first fluid,
wherein a detection system operates to detect damage to one or more components within said plurality of cells based on said vibration signals.

12. The electrolyzer of claim 11, wherein each cell of said plurality of cells comprises a corresponding membrane separating said corresponding cathode from said corresponding anode,
wherein said damage includes a rupture in the membrane in one or more cells of said plurality of cells.

13. The electrolyzer of claim 11, wherein said sensor comprises an accelerometer sensor, wherein said accelerometer sensor provides time-domain acceleration magnitudes corresponding to instantaneous vibrations of said first pipe when carrying said first fluid.

14. The electrolyzer of claim 13, wherein said detection system comprises:
a converter operable to receive vibration signals from said accelerometer sensor and to generate corresponding digital signals; and
a digital processor operable to:
generate a baseline characterizing vibration signals for normal operation of said electrolyzer;
receive digital signals representing vibration signals in a current duration;
compare said digital signals received in said current duration with said baseline;
determine whether said comparison indicates damage to one or more components,
wherein if said determination indicates damage to one or more components, said digital processor generates a control signal indicating said damage.

15. The electrolyzer of claim 14, wherein said membrane comprises a polymer electrolyte membrane, wherein said electrolyzer further comprises:
a second pipe to transfer water into said plurality of cells;
a first control valve operable to open or close said first pipe; and
a second control valve operable to open or close said second pipe.

16. The electrolyzer of claim 15, wherein said electrolyzer further comprises a stack management system operable to perform one or more corrective actions upon receiving said control signal, wherein said corrective actions include:
generating an alert;
electrically disengaging a stack containing said plurality of cells; and
closing said first control valve and/or said second control valve.

17. The electrolyzer of claim 14, wherein said stack further comprises a plurality of sealing components, wherein said damage includes a rupture in one or more of said sealing components.

18. A non-transitory machine-readable medium storing one or more sequences of instructions, wherein execution of said one or more instructions by one or more processors contained in a digital processing system cause said digital processing system to perform the actions of:
receiving digital data representing vibration signals from a sensor mounted on a first pipe carrying a first fluid away from a stack of an electrolyzer, said stack producing said first fluid containing oxygen and a second fluid containing hydrogen upon application of voltage across said stack; and
detecting damage to one or more components within said stack by examining said digital data representing said vibration signals.

19. The non-transitory machine-readable medium of claim 18, to perform said detecting, said digital processing system performs the further actions of:
generating a baseline characterizing said vibration signals based on a first subset of digital data of said digital data received during normal operation of said electrolyzer;
receiving a second subset of digital data of said digital data in a current duration;
comparing said second subset of digital data received in said current duration with said baseline;
determining whether said comparison indicates damage to one or more components,
wherein if said determining indicates damage to one or more components, generating a control signal indicating said damage.

20. The non-transitory machine-readable medium of claim 19,
to perform said generating of said baseline, said digital processing system performs the further actions of:
sampling said first subset of digital data in a set of time durations of normal operation of said electrolyzer;
performing Fast Fourier Transform (FFT) of said sampled first subset of digital data for each time duration of said set of time durations to generate a corresponding set of FFT results, each FFT result including a set of frequencies and a corresponding amplitude at each frequency;
calculating a corresponding average for each frequency of said set of frequencies, the corresponding average being an average of respective amplitudes for the frequency in corresponding FFT result, the corresponding averages and said set of frequencies constituting a baseline-FFT-result;
computing a corresponding root mean square of power spectral density of each FFT result of said set of FFT results, and then an average of the root mean square values as a first threshold; and
calculating a corresponding mean square of amplitudes in each FFT result of said set of FFT results, and then an average of the mean square values as a second threshold,
wherein said baseline-FFT-result, said first threshold and said second threshold together constitute said baseline,
wherein to compare said second subset of digital data received in said current duration with said baseline, said digital processing system performs the further actions of:
performing FFT of said second subset of digital data received in said current duration to generate an observed-FFT-result, said observed-FFT-result including said set of frequencies and a corresponding observed-amplitude at each frequency of said set of frequencies;
compute a set of difference-amplitudes with each difference-amplitude of said set of difference-amplitudes being a difference between the observed-amplitude and the corresponding average of said baseline-FFT-result at a corresponding frequency of said set of frequencies,
wherein said digital processing system concludes damage to one or more components based on said set of difference-amplitudes.
